(19) United States
(12) Patent Application Publication
(10) Pub. No.: US 2005/0168769 A1
(43) Pub. Date: Aug. 4, 2005

(54) Security print system and method

(75) Inventors: Byoung-Yue Kim, Suwon-si (KR); Sang-Eun Han, Gwacheon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/030,161

(22) Filed: Jan. 7, 2005

(30) Foreign Application Priority Data
Jan. 31, 2004 (KR) 2004-6382

(51) Int. Cl. G06F 3/12; G08B 29/00

(52) U.S. Cl. 358/1.14; 340/5.81

(57) ABSTRACT

A print system and method are presented, wherein the present print system comprises a management database for storing information on documents and information on persons authorized to print the documents, an authentication part for determining whether a person requesting the printing is authorized to print the documents, and issuing an authentication number upon requesting prints of the documents, a print data converter for converting the document and the authentication number issued from the authentication part into a printer control language that the printer can recognize, and a controller for, upon requesting the printing of the documents, requesting the authentication part to authenticate the person requesting the printing of the documents, and, if the person is authorized to print the documents, activating the print data converter to convert the documents and the authentication number into the printer control language for printing. Thus, only the persons printing the document and authorized in advance are allowed to print confidential documents, so that such confidential documents can be substantially prevented from being released without authorization, printed, or lost. Furthermore, as well as the confidential document can be substantially prevented from being distributed by the person printing the document without permission.

### CROSS-REFERENCE TO RELATED APPLICATIONS

This application claims priority under 35 U.S.C. § 119(a) from Korean Patent Application No. 2004-6382, filed on Jan. 31, 2004 in the Korean Intellectual Property Office, the entire contents of which are hereby incorporated by reference.

### BACKGROUND OF THE INVENTION

1. Field of the Invention

The present invention relates generally to a print system and method. More particularly, the present invention is directed to a print system and method for determining, upon a request to print confidential documents, whether the person who requests the printing is properly authorized, authenticating the person printing the document, recording information regarding confidential documents and the person printing the document on the prints, thereby preventing confidential documents from being improperly disseminated.

2. Description of the Related Art

Corporations and businesses today carry out many tasks through the use of computers, that are connected to outside networks through a local area network (LAN) or a wide area network (WAN). As a result, situations in which classified or confidential data (i.e., proprietary documents and drawings that should only be used inside the companies) is stolen, leaked, or lost through the network have increased.

Various efforts are being made to prevent such confidential data from being stolen, leaked, or lost through the networks. In particular, in such work environments in which tasks are carried out through networks and proprietary documents are printed through printers connected to such networks, consideration has to be taken regarding the security of the computers, databases, networks, and printing of documents, in order to build a better security system.

For the security of the computers, several approaches are used. These include verifying identifications (IDs) of the user(s), limiting the authority of copying onto floppy discs or compact disc (CD) writers, and limiting data sharing with other computers through a security cable (e.g., an FX cable).

As for the databases, security approaches include knowledge management system (KMS) and enterprise document management system (EDMS). These security systems allow read-only or write-only to prevent the person printing the documents from accessing any other documents stored in databases.

As for the networks, security approaches include trying to limit hackers' and crackers' access to the networks and creating firewalls and the like for data protection. In regard to printed documents, one security approach specifies who has the responsibility for the printed documents to protect and prevent proprietary data from being lost.

In many business environments, however, documents are generally printed through the process illustrated in FIG. 1. After a writer creates a document by using an application program 122, the document is stored in a memory of the computer regardless of the degree of importance of the document, and, if the person printing the document selects the print command, the document stored in the memory is converted into a printer control language by the printer driver 123, and then sent to a print spooler 124. The language-converted document is then sent to a printer through a port monitor 125 by use of a network protocol. Subsequently, the printer prints the document requested by the person printing the document.

It is not known whether the document was printed by an authorized person. Also, it is not known whether the person who actually takes the printed document from the printer is authorized to do so, even though the printing was made by an authorized person. Furthermore, even if an authorized person receives the document, the one who received the prints of the document cannot tell who printed the document. As a result, there is substantially little or no security with respect to prints of documents.

Some solutions have been developed for the security of confidential documents in a printing process in view of the problem discussed above. One solution is to use the Digital Rights Management (DRM) technology that prevents modifications or unauthorized inspection of information by distributing the confidential documents to specific authorized persons as encrypted files. A valid period is specified, after which access is denied and access to the confidential documents cannot be obtained if one does not know his or her password. Other approaches have been proposed, one of which is to basically prevent modifications and unauthorized inspections of documents by automatically converting documents in various formats such as MS word and PowerPoint into PDF files, and another of which is to encode documents and permit only authorized persons to inspect the document content.

Such conventional security solutions for the process of printing confidential documents are mainly focused on encoding the documents and limiting the treatments of the encoded confidential documents depending on what authority a person has to the documents. Thus, when security solutions for the process of printing confidential documents are used, the expenses for purchasing and maintaining encryption solutions for encoding documents rises, as well as the need for more expenses and labor due to extra management resulting from difficulties in maintaining and managing the encryption solutions.

Furthermore, conventional security solutions for printed documents have the problem that no security is substantially taken on photocopying or leaking-out of the printed documents. Specifically, if an owner of confidential documents or one who has been given access to the confidential document, photocopies and gives confidential-level files to unauthorized persons, or distributes the printed copies of the files to unauthorized people, the information in the confidential files can be exposed to third parties that do not have the authority to access the confidential documents. The prints of the confidential files do not contain security information such as confidential grade, file owner, ID of person printing the document, and printing time, which can cause information to be leaked out easily and without responsibility.

### SUMMARY OF THE INVENTION

The present invention has been developed in order to solve the above and other drawbacks associated with the conventional arrangement. An exemplary aspect of the present invention is to provide a print system and method capable of preventing confidential documents from being leaked (or an unauthorized release to third parties) by determining, when a request is made for printing documents in security, whether a person who requests prints of the documents is properly authorized, authenticating the person printing the document, and recording information of the person and documents on the prints of the documents.

The forgoing and other aspects and advantages are substantially realized by providing a print system having a computer with a printer driver installed therein, and a printer connected through a network to the computer for printing documents created in application programs installed in the computer. The print system includes a management database (DB) for storing information on documents and information on persons authorized to print the documents, an authentication part for determining whether a person requesting the printing is authorized to print the documents and issuing an authentication number upon requesting prints of documents, a print data converter for converting the document and the authentication number issued from the authentication part into a printer control language that the printer can recognize, and a controller for requesting the authentication part to authenticate the person requesting the prints of the documents upon requesting the printing of the documents. If the person is authorized to print the documents, the print data converter is activated to convert the documents and the authentication number into the printer control language for printing.

According to an embodiment of the present invention, the authentication number contains information that comprises at least one of document content, kind, security grade, and information on the person who requested the printing. The authentication number is printed on a print in at least one of a barcode, a watermark, and a number format.

The documents stored in the management DB are in an exemplary embodiment of the present invention classified into a plurality of security grades depending on confidential degrees. The persons authorized to print the documents are classified into a plurality grades depending on the security grades.

The print system further comprises a print management part for issuing to the person printing the document a unique print number identifying a document as a print. The print management part according to an embodiment of the present invention also issues a print history DB for storing information containing at least one of information on whether to be authenticated, authentication numbers, and information on person printing the document, together with the unique print number.

The forgoing and other aspects and advantages of the present invention are substantially realized by providing a print method using a computer with a printer driver installed therein, and a printer connected through a network to the computer and for printing documents created in application programs installed in the computer. The print method comprises building a management database (DB) for storing information on documents and information on persons authorized to print the documents, determining whether a person requesting the printing is authorized to print the documents and issuing an authentication number upon requesting prints of the documents, issuing to the person printing the document a unique print number identifying a document as a print, converting the document and the authentication number issued from the authentication part into a printer control language that the printer can recognize, and controlling the document and authentication number converted into the printer control language to be printed.

In an exemplary embodiment of the invention, the management DB building process classifies the documents into the plurality of security grades depending on confidential degrees, and classifies the persons authorized to print the documents into the plurality of grades according to the security grades. The print method comprises includes building a print history DB for storing information containing at least one of the following information: decisions regarding whether to authenticate a person, authentication numbers, and information on person printing the document, and the unique print number.

### BRIEF DESCRIPTION OF THE DRAWING FIGURES

The above aspects and features of the present invention will be more apparent by describing certain embodiments of the present invention with reference to the accompanying drawing figures, in which:

FIG. 1 is a flowchart illustrating a print process of a conventional printer;

FIG. 2 is a block diagram illustrating a security print system according to an embodiment of the present invention;

FIG. 3 is a detailed block diagram illustrating the security print system of FIG. 2;

FIG. 4A is a view illustrating prints printed by the security print system of FIG. 3;

FIG. 4B is a view illustrating another prints printed by the security print system of FIG. 3; and

FIG. 5 is a flowchart illustrating a security print process of the security print system according to an embodiment of the present invention.

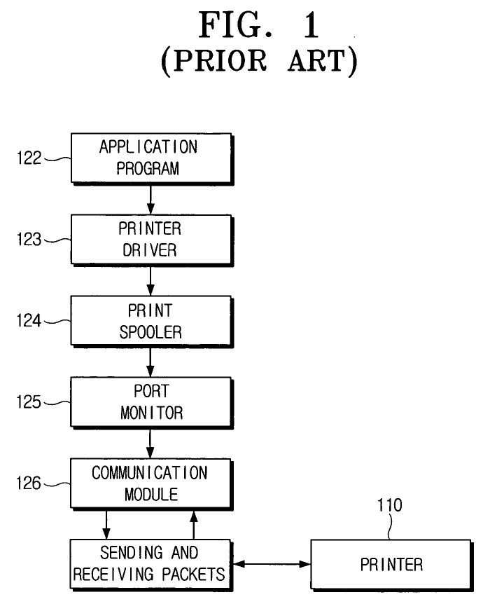

### DETAILED DESCRIPTION OF EXEMPLARY EMBODIMENTS

Hereinafter, the present invention will be described in detail with reference to the accompanying drawing figures. In the drawings, the same or similar elements are denoted by the same reference numerals even though they are depicted in different drawings. In the following description, a detailed description of known functions and configurations incorporated herein have been omitted for conciseness and clarity.

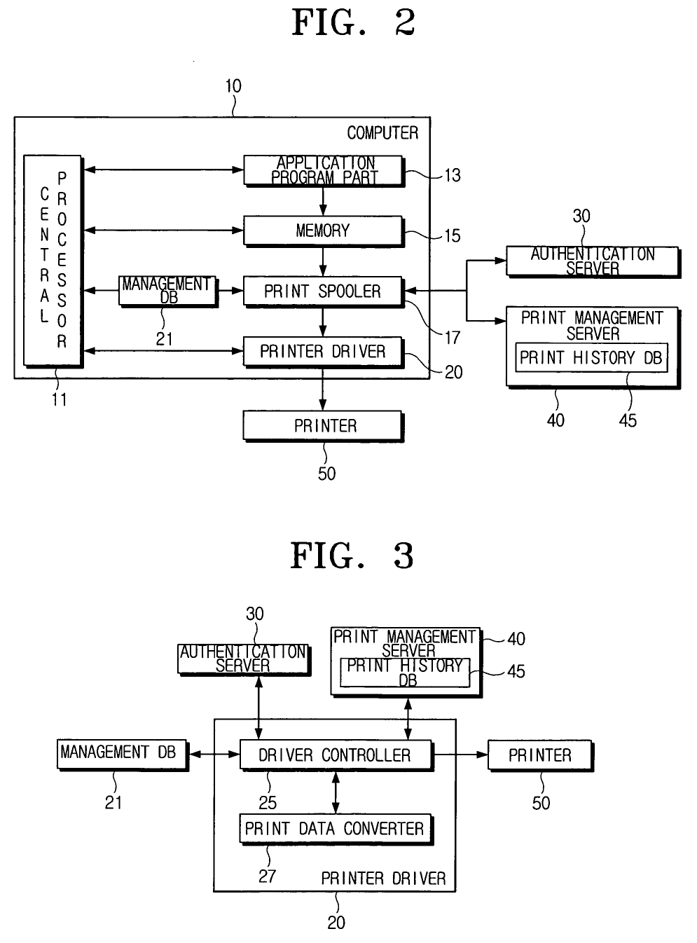

FIG. 2 illustrates a security print system according to an embodiment of the present invention, and FIG. 3 is a detailed block diagram of the security print system of FIG. 2. The security print system has a computer 10, a printer 50 connected for communication to the computer 10 through a network to print documents created in the computer 10, an authentication server 30 for authenticating a person printing documents, and a print management server 40 for issuing unique print numbers to the authenticated person and the confidential documents to be printed by the authenticated person.

The network refers to any of wired and wireless communication networks such as the internet, local area network (LAN), wide area network (WAN), communication networks formed with identical or similar LANs connected by bridges, communication network formed with different LANs connected by a gateway, and wireless communication network such as Bluetooth. The computer 10, printer 50, authentication server 30, and print management server 40 can be installed in the same LAN or at remote places. The above described network description is not meant to be limiting, but rather is provided as an example, and any other type of network designed for electronic communications can be used in any of the embodiments of the present invention.

The computer 10 has an application program part 13 for creating documents, a memory 15 for storing the documents created in the application program part 13, and a printer driver 20, a management database (DB) 21, and a print spooler 17 for printing out the documents created in the application program part 13. In addition, the computer 10 has a central processor 11 for controlling operations of the application program part 13, printer driver 20, management DB 21, and print spooler 17.

Application programs for creating documents can include word processor programs such as MS Word™, EXEL™ for calculations such as accounting, PhotoShop™ for graphics, and Notepad™ for creating HTML documents or viewing source codes. The types of application programs that can be used with the embodiments of the present invention is virtually limitless, and substantially all application programs that have a print feature can be used in conjunction with any of the embodiments of the present invention.

The printer driver 20 converts documents created in an application program of the computer 10 into a printer language (hereinafter, referred to as ‘printer control language’) that can be interpreted in the printer 50. The printer control language consists of commands that the computer 10 sends to the printer 50 in order to instruct how printed copies are configured, and such commands manages font sizes, graphics, compression of data to be sent to the printer 50, and colors. PostScript™ and PCL™ are two such well known examples of printer control languages. The print data converted by the printer driver 20 is temporarily contained in the print spooler 17, and sent to the printer in the order stored in the printer spooler 17, so that the print data is printed.

As shown in FIG. 3, the printer driver 20 has a print data converter 27 and a driver controller 25, and can exchange data with the management DB 21. The management DB 21 classifies and stores by security grade the documents created in the application program 13 and stored in the memory of the computer 10, and also stores information on persons who can inspect and print the documents.

Among the documents stored in the memory 15 of the computer 10, the management DB 21 contains information on classified or confidential documents to which unconcerned or unauthorized persons have limited access for inspection or printing, wherein such information comprises file names, file formats, file sizes, and summaries of the confidential documents, and classification symbols by department to which the confidential documents belong. The management DB 21 contains information on concerned persons that are authorized to inspect the confidential documents, such as employee numbers, department names, employee names, and positions. The confidential documents can be classified into multiple security levels depending on security grades, and persons authorized to inspect or print can be classified into multiple security levels according to the classification of the confidential documents into the multiple security levels.

As an example of such classification, if the security grades of the confidential documents are classified into a high level, middle level, and low level, settings can be established in order that the inspection and printing of the confidential documents classified into the high level can be limited only to persons higher in position than department chiefs, the inspection and printing of the confidential documents classified into the middle level can be limited only to persons higher in position than team leaders, and the inspection and printing of the confidential documents classified into the low level can be limited only to persons higher in position than researchers in related departments. This presumes, of course, that department chiefs receive high security grades, team leaders receive middle level security grades or lower, and researchers receive no security grade at all. Many different classification methods can be applied and varied depending upon their practical applications as to the security grade levels of the confidential documents and as to the authorization levels of persons authorized to inspect and print the confidential documents, according to the security levels of the documents.

Various methods can be applied to establishing the security grades of the confidential documents. For example, the security grades can be classified by the writers of the confidential documents, or by persons higher in position than the writers of the confidential documents through some approval steps based on the positions of the writers. The security grades can also be classified automatically by the management DB 21 upon registration of the confidential documents based on, for example, various predetermined criteria.

The print data converter 27 converts print data into a printer control language. When a confidential document is converted into the printer control language, an authentication number issued by the authentication server 30, which will be described in greater detail below, is also converted, together with the confidential document, into the printer control language. The print data converter 27 sets a location on the printed copies on which a unique print number is provided, and the unique print number preferably appears on both sides on the upper portion or on both sides on the lower portion of the printed copies.

Upon printing of a confidential document, the driver controller 25 requests authorization to the authorization server 30 in order to determine whether the person requesting the printing is authorized to inspect or print the corresponding confidential document. If the authorization server 30 authenticates the person to inspect or print the confidential document and issues an authentication number, the driver controller 25 requests the print management server 40 to provide a unique print number which is the number by which the print can be identified. If the unique print number is issued by the print management server 40, the print data of the confidential document is sent to the print data converter 27 together with the unique print number and the authentication number. The confidential document, authentication number, and unique print number are then converted into the print control language. If the print data converter 27 completes the conversion, the driver controller 25 provides the print data of converted confidential document and unique print number to the print spooler 17. The print spooler 17 then spools and sends the print data to the printer 50 for printing so as to print the data. If the printing is completed, the driver controller 25 notifies the print management server 40 of the completed printing and the authentication result of the authentication server 30.

The authentication server 30 for authenticating a person printing the document, determines whether the person is authorized to view or print the confidential document requested for printing by the driver controller 25. If the person is to take the confidential document out of the memory 15 for printing, the driver controller 25 requests the authentication server 30 to authenticate the person, and the authentication server 30 asks the person to input information for authentication purposes. The authentication information can be an identification (ID) and a password assigned to each person, and the ID and password can be directly input through an input device such as a keyboard or a mouse or by use of a smart card.

The smart card can employ a one-time password (OTP) system that changes passwords each time. Thus, the use of a disposable password that is valid only once makes it safe despite password sniffing. Newly generated passwords will be used next time. In addition to the OTP system, other systems and methods exist for generating passwords, such as the S/Key system, the challenge-response (CR) system, and the time-synchronous system. The S/Key system is a simple authentication system for protecting a password of a person printing the document against passive attacks. In the CR system, if a person printing the document logs on, a server issues a challenge message, and the person printing the document produces an OTP for an answer by combining a personal identification number (PIN) and the challenge. The server generates the OTP by using the information of the same challenge and registered person printing the document, and compares the OTP to the answer of the person requesting to print the document, and authenticates the person printing the document. The time-synchronous approach generates a 64-bit encryption key every time t fixed by an administrator of a random number generation algorithm, so that a particular encryption key is assigned to the person printing the document. The information of the encryption key assigned to the person printing the document is stored in an intelligent token (token) and the database of the authentication server 30. When the person printing the document logs on to the server, the server sends six random numbers generated by combining the PIN and token, and the random numbers are generated through an algorithm in the token based on the initial value of t and a secret number stored in the token. When ten numbers generated as above are provided to the server, the server determines the corresponding encryption key, and generates six random numbers, using the PIN as an index, and determines whether the generated six random numbers match with the received ones.

The authentication server 30 verifies whether the secret number matches the ID input using the methods described above, and the person printing the document is then authorized to access and print the corresponding confidential document. The authentication server 30 determines whether the person printing the document is an employee of the company and authorized to inspect and print the confidential document as an employee. The authentication server 30 requires information on the person printing the document and the confidential document itself, so that the person printing the document can inspect and print the document, and the information can be stored in advance in a library file, in a DB form, or in the management DB 21 for use.

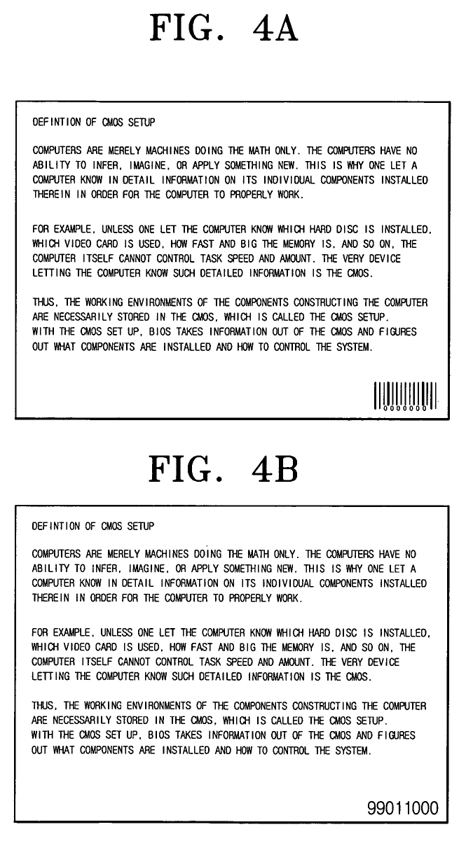

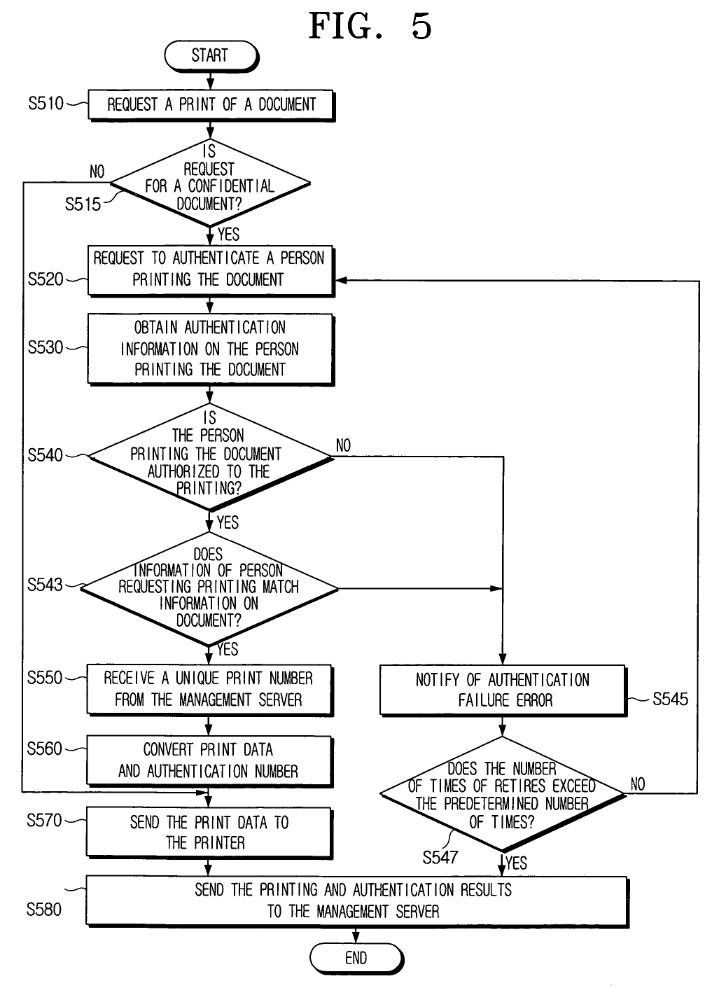

If the authentication server 30 authenticates the print requester, an authentication number is assigned to each of the confidential documents. The authentication number that appears on the confidential document to be printed can be printed in a barcode format on the bottom right hand corner of one side of the print as shown in FIG. 4A, in a number format as shown in FIG. 4B, or in a watermark format. Printing in the barcode format has the advantage that information relating to an authentication number can be obtained by use of a barcode reader, and printing in the watermark format has the advantage that one can recognize the confidential document as printed. The authentication number can contain a classification symbol and security grade depending on the content of the print, information on a person who printed employee number or ID, department name, and security grade related to the print.

If the person printing the document is authenticated using the methods described above, the print management server 40 generates a unique print number enabling the print to be identified according to a request by the driver controller 25. The unique print number can be a number randomly generated by the print management server 40. The unique number can also be sequentially or randomly assigned regarding print order.

The print management server 40 is provided with the print history DB 45 that stores a print history of confidential documents. The print history DB 45 stores information on whether or not the confidential document has been printed, authentication results as to whether authentication is received by the authentication server 30, a reason for printing, and person printing the document. The print history DB 45 matches the information described above with the unique print number. If a person printing the document fails to be authenticated as a person authorized to print the document in the authentication process using the authentication server 30, the print history DB 45 stores the input ID and password. The data is used in future in order to prevent confidential documents from being printed by unauthorized persons. The information stored in the print history DB 45 is provided from the driver controller 25 after the printing is completed. The print history stored in the print history DB 45 indicates who has printed which confidential documents and for what purpose.

Referring now to FIG. 5, the method for performing a security print process of a security print system having the structure as discussed above will now be described. Prior to using the method for printing according to an embodiment of the present invention, a person will create a document in an application program. If the created document is considered a confidential document, the person creating the document will give a security grade to the document and register the document with the management DB 21. Based on the security grade classification, it is determined who can be authorized to inspect and print the corresponding confidential document.

If the management DB 21 is built and a person requests a print of a document as a printout, the central processor 11 of the computer 10 sends a printing-requested document (target document) to the printer driver 20 at step S510. The driver controller 25 of the printer driver 20 compares information on the target document to information on the stored confidential documents, and determines whether the target document is a confidential document in decision step S515. If the target document is not a confidential document, the driver controller 25 sends the target document to the print data converter 27, and the print data converter 27 converts the target document into a printer control language (“No” path from decision step S515). Then, the converted target document is sent to the printer 50 through the print spooler 17 and a print of the target document is printed according to the general printout process (step S570).

If the target document is a confidential document as a result of the determination in decision step S515 (“Yes” path), the driver controller 25 requests the authentication server 30 to authenticate the person printing the document at step S520, and the authentication server 30 asks the person printing the document to input his or her ID and password. The method then determines, in decision step S540, whether the person is authorized to print the confidential document. The authentication server 30 determines whether the ID and password input by the person printing the document match. If the ID and password do not match, the authentication server 30 notifies that the authentication fails at step S545 (“No” path from decision step S540) and allows the person printing the document to input his or her ID and password again up to the predetermined number of times. If the number of times of retries exceeds the predetermined number of times, however, (“Yes” path from decision step S547) the authentication server 30 terminates the authentication process at decision step S547, and the driver controller 25 sends the authentication failure and information of the input ID and password to the print management server 40 at step S580.

If the ID and password match (“Yes” path from decision step S540), the authentication server 30 matches information on the person printing the document obtained by the ID with information on the confidential document in decision step S547. If the person is not authorized to print the confidential document, (“No” path from decision step S543) the authentication server 30 does not authenticate the person printing the document even though the ID and password match, and the driver controller 25 notifies the person printing the document of ‘unauthorized person’ through a message (in step S545). Just as when a person was found not to be authorized in decision step S540, a person whose information was found not to match the confidential document up to a predetermined amount of times through decision step S547. If the person is authorized to print the confidential document, the authentication server 30 notifies the driver controller 25 that the person is authenticated, and generates an authentication number at the same time. As described above, the authentication number can be formed in the barcode, number, or watermark format. When authentication is completed, the driver controller 25 sends information on the person printing the document and the confidential document information to the print management server 40, requests a unique print number, and receives the unique print number from the print management server 40 at step S550.

The driver controller 25 sends to the print data converter 27 the confidential document requested by the person printing the document and the authentication number received from the authentication server 30 at step S560. The print data converter 27 converts the confidential document and the authentication number into a printer control language. At the same time, the print data converter 27 sets a location, (i.e., an upper portion, a lower portion, or a central portion) for watermark format, on the print paper, on which the authentication number can be printed in a predetermined format.

The driver controller 25 sends the converted confidential document and the print data for the authentication number to the print spooler 17, and the print spooler 17 sequentially sends print jobs to the printer 50 for printing in print order at step S570. When the print job is completed, the driver controller 25 sends to the print management server 40 information on whether the print job is normally terminated, information on whether to be authenticated, the authentication number, and the person printing the document, together with the unique print number received from the print management server 40 at step S580. The print management server 40 stores the information sent from the driver controller 25 into the print history DB 45, matching with the unique print number assigned in advance.

As described above, the security print system according to the various embodiments of the present invention classifies into multiple security levels confidential documents and persons authorized to inspect and print the confidential documents, and determines, when a person requests a print of a confidential document, whether the person is authorized (or not) to print the corresponding confidential document. Subsequently, the security print system described herein permits or prohibits the printing. If the printing is permitted to an authorized person, the system prints the confidential document together with an authentication number received from the authentication server 30 so that information on the authorized person can be easily obtained.

Since only the persons authorized in advance are allowed to inspect and print confidential documents, the print system can substantially prevent confidential documents from being released without authorization, printed, or lost. By virtue of the features of the embodiments of the present invention, an individual can easily determine the information on a person that printed a document by the authentication information printed on a confidential document. Thus, if the person who printed the document distributed the confidential document to an authorized third party, it would be easy to determine the person who printed and/or distributed the confidential document by the authentication information printed on the confidential document. Hence, the print system according to the embodiments of the present invention can substantially prevent the person who printed the documents from distributing confidential documents without permission.

The aforementioned exemplary embodiments has the computer 10 separated from the devices of the authentication server 30 and the print management server 40, but the devices can be configured in an independent process, or in a file or a library format.

According to the embodiments of the present invention, since only the persons printing the document and authorized in advance are allowed to inspect and print confidential documents, the confidential documents can be substantially prevented from being released without authorization, printed, or lost. Since one can easily obtain the information on the person that printed the document by the authentication information printed on a confidential document, the confidential document can be substantially prevented from being distributed by the person printing the document without permission.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A print system having a computer with a printer driver installed therein, and a printer connected to the computer for printing documents created in application programs installed in the computer, the print system comprising:
a management database (DB) for storing information on documents and information on persons authorized to print the documents;
an authentication part for determining whether a person requesting the printing is authorized to print the documents and issuing an authentication number upon requesting prints of documents;
a print data converter for converting the document and the authentication number issued from the authentication part into a printer control language that the printer can recognize; and
a controller for requesting the authentication part to authenticate the person requesting the prints of the documents upon requesting the printing of the documents and, if the person is authorized to print the documents, activating the print data converter to convert the documents and the authentication number into the printer control language for printing.

2. The print system as claimed in claim 1, wherein the authentication number contains at least one of document content, kind, security grade, and information on the person who requested the printing.

3. The print system as claimed in claim 1, wherein the authentication number is printed on a print in at least one of a barcode, a watermark, and a number format.

4. The print system as claimed in claim 1, wherein the documents stored in the management DB are classified into a plurality of security grades depending on confidential degrees, and the persons authorized to print the documents are classified into a plurality of grades according to the plurality of security grades.

5. The print system as claimed in claim 1, further comprising:
a print management part for issuing to the person printing the document a unique print number identifying a document as a print; and
a print history DB for storing information containing at least one of information on whether to be authenticated, authentication numbers, and information on the person printing the document, together with the unique print number.

6. A print method using a computer with a printer driver installed therein, and a printer connected through a network to the computer and for printing documents created in application programs installed in the computer, the print method comprising:
building a management database (DB) for storing information on documents and information on persons authorized to print the documents;
determining whether a person requesting the printing is authorized to print the documents and issuing an authentication number upon requesting prints of the documents;
issuing to the person printing the document a unique print number identifying a document as a print;
converting the document and the authentication number issued from an authentication part into a printer control language that the printer can recognize; and
controlling the document and authentication number converted into the printer control language to be printed.

7. The print method as claimed in claim 6, wherein the authentication number contains at least one of document content, kind, security grade, and information on the person who requested the printing.

8. The print method as claimed in claim 6, wherein the authentication number is printed on a print in at least one of barcode, watermark, and number formats.

9. The print method as claimed in claim 6, wherein the management DB-building classifies the documents into a plurality of security grades depending on confidential degrees, and classifies the persons authorized to print the documents into a plurality of grades according to the security grades.

10. The print method as claimed in claim 6, further comprising building a print history DB for storing information containing at least one of information on whether to be authenticated, authentication numbers, and information on the person printing the document, together with the unique print number.
